(19) United States
(12) Patent Application Publication
(10) Pub. No.: US 2021/0144668 A1
(43) Pub. Date: May 13, 2021

(54) WEARABLE TERMINAL, GROUP MANAGEMENT SYSTEM, AND WEARABLE TERMINAL CONTROL METHOD

(71) Applicant: NEC Corporation, Tokyo (JP)

(72) Inventor: Kyoko OTSUKA, Tokyo (JP)

(73) Assignee: NEC Corporation, Tokyo (JP)

(21) Appl. No.: 17/086,875

(22) Filed: Nov. 2, 2020

(30) Foreign Application Priority Data
Nov. 7, 2019 (JP) 2019-202146

(51) Int. Cl. H04W 64/00; H04W 4/90; H04B 1/3827; H04W 52/02; G01S 5/00; G01S 5/02

(52) U.S. Cl. CPC H04W 64/00; H04W 4/90; H04B 1/385; H04W 84/042; G01S 5/019; G01S 5/0236; H04W 52/0225

(57) ABSTRACT

In order to promptly specify, with low power consumption, a location of a wearable device departed from a group, the wearable terminal includes a short-distance radio communicator, a location information report request receiver, a location information acquisition unit, and a long-distance radio communicator. The short-distance radio communicator normally performs short-distance radio communication with another wearable terminal. The location information report request receiver receives an externally transmitted location information report request requesting a wearable terminal to report location information of the local terminal to a specified destination. When the location information report request receiver receives the location information report request, the location information acquisition unit acquires location information of the local terminal. The long-distance radio communicator transmits the acquired location information to a destination specified by the location information report request.

This application is based upon and claims the benefit of priority from Japanese Patent Application No. 2019-202146, filed on Nov. 7, 2019, the disclosure of which is incorporated herein in its entirety by reference.

### TECHNICAL FIELD

The present invention relates to a wearable terminal, a group management system and wearable terminal control method.

### BACKGROUND ART

There is a situation in which a location of each member needs to be grasped in a group of people such as aged people suffering from dementia, infants and/or children, a correctional institution, a group tour, and leisure-time amusements or sports by a group. Methods of meeting such a need have been under study.

For example, PTL 1 (Japanese Patent No. 5476861) discloses a method of each operator constituting a group wearing a wearable terminal, and each wearable terminal acquiring GPS positioning information and transmitting location information of the local terminal to a control center. The method allows grasping of locations of operators. PTL 1 also discloses a method of transferring location information between wearable terminals by use of short-distance radio and transmitting the location information from a repeater to the control center. Use of the method keeps a communication fee low.

### SUMMARY

However, the technology in PTL 1 has a problem that power consumption of a wearable terminal is high. In the technology, a wearable terminal performs reception of a Global Positioning System (GPS) signal and calculation of a location at predetermined intervals. Consequently, power consumption cannot be reduced.

The present invention has been made in view of the aforementioned problem, and an object of the present invention is to provide a wearable terminal having low power consumption and being capable of promptly specifying a location of a wearable terminal departed from a group.

In order to resolve the aforementioned problem, the wearable terminal includes a short-distance radio communication means, a location information report request reception means, a location information acquisition means, and a long-distance radio communication means. The short-distance radio communication means normally performs short-distance radio communication with another wearable terminal. The location information report request reception means receives an externally transmitted location information report request requesting a wearable terminal to report location information of the local terminal to a specified destination. When the location information report request reception means receives the location information report request, the location information acquisition means acquires location information of the local terminal. The long-distance radio communication means transmits the acquired location information to a destination specified by the location information report request.

As described above, the present invention can provide a wearable terminal having low power consumption and being capable of promptly specifying a location of a wearable terminal departed from a group.

### BRIEF DESCRIPTION OF THE DRAWINGS

Exemplary features and advantages of the present invention will become apparent from the following detailed description when taken with the accompanying drawings in which:

FIG. 1 is a block diagram illustrating a wearable terminal according to a first example embodiment;

FIG. 2 is a schematic diagram illustrating a group management system according to a second example embodiment;

FIG. 3 is a schematic diagram illustrating a positional relation between terminals in a group management system according to a third example embodiment;

FIG. 4 is a block diagram illustrating the group management system according to the third example embodiment;

FIG. 5 is a sequence diagram illustrating an operation of the group management system according to the third example embodiment;

FIG. 6 is a schematic diagram illustrating a positional relation between terminals in a group management system according to a fourth example embodiment;

FIG. 7 is a block diagram illustrating the group management system according to the fourth example embodiment;

FIG. 8 is a sequence diagram illustrating an operation of the group management system according to the fourth example embodiment;

FIG. 9 is a sequence diagram illustrating another operation of the group management system according to the fourth example embodiment;

FIG. 10 is a schematic diagram illustrating a positional relation between terminals in a group management system according to a fifth example embodiment;

FIG. 11 is a block diagram illustrating the group management system according to the fifth example embodiment; and

FIG. 12 is a sequence diagram illustrating an operation of the group management system according to the fifth example embodiment.

### EXAMPLE EMBODIMENT

Example embodiments of the present invention will be described in detail below with reference to drawings. Although technically preferred limitations for implementing the present invention are applied to the example embodiments described below, the scope of the invention is not limited thereto. The same numeral is given to similar components in the drawings, and description thereof may be omitted.

### First Example Embodiment

FIG. 1 is a block diagram illustrating a wearable terminal 10 according to the present example embodiment. The wearable terminal 10 includes a short-distance radio communication means 1, a location information report request reception means 2, a location information acquisition means 3, and a long-distance radio communication means 4.

The short-distance radio communication means 1 normally performs short-distance radio communication with another wearable terminal. The short-distance radio communication is assumed a communication method having low power consumption and a communication distance ranging from several meters to several tens of meters. Examples of a specific short-distance radio communication method that may be used include Bluetooth (registered trademark) and Zigbee (registered trademark).

The location information report request reception means 2 receives an externally transmitted location information report request requesting a wearable terminal 10 to report location information of the wearable terminal 10 to a specified destination.

When the location information report request reception means 2 receives a location information report request, the location information acquisition means 3 acquires location information of the local terminal. For example, the location information is GPS data.

The long-distance radio communication means 4 transmits acquired location information to a destination specified by a location information report request. For example, the long-distance radio communication means 4 is a communication unit using a communication method having a communication distance ranging from several kilometers to several tens of kilometers. Examples of a specific communication method that may be used include various methods based on low power wide area (LPWA) and long term evolution (LTE).

As described above, the wearable terminal according to the present example embodiment normally performs short-distance radio communication having low power consumption and only when receiving a location information report request, starts the location information acquisition means and the long-distance radio communication means that have high power consumption and reports location information of the local terminal to a specified destination. Accordingly, a location of a wearable terminal departed from a group can be promptly specified while power consumption of wearable terminals is kept low.

### Second Example Embodiment

A group management system managing a group formed of a plurality of people, animals, and/or the like can be configured by use of the wearable terminals 10 according to the first example embodiment. A group is herein defined as members gathering in a range in which short-distance radio can be performed. The group may be moving.

In order to perform group management, first, each member constituting the group wears a wearable terminal 10. Then, the wearable terminals 10 form an ad hoc communication network using short-distance radio. FIG. 2 is a schematic diagram illustrating an example of such a group management system 20. First, as illustrated in Diagram (a) in FIG. 2, a plurality of wearable terminals 10 (10a to 10d) form an ad hoc communication network 31 by use of short-distance radio communications 30 using the short-distance radio communication means 1. The wearable terminals 10 periodically confirm each other's location by use of short-distance radio communication.

As illustrated in Diagram (b) in FIG. 2, it is assumed that a wearable device 10 departs from the group; in other words, the terminal departs from a range in which short-distance radio communication can be performed. An example of the wearable device 10c departed from the group is illustrated. Then, other wearable devices 10 detect that the location of the wearable device 10c cannot be confirmed. When departure of the wearable device 10c is detected, a location information report request 50 is transmitted from a management terminal to the wearable device 10c by use of a long-distance radio communication 40. Then, the location information report request reception means 3 in the wearable device 10c receives the location information report request. When receiving the location information report request, the wearable device 10c starts the location information acquisition means 4 and acquires location information. Then, the wearable device 10c transmits the location information of the local terminal to a destination specified by the location information report request by use of the long-distance radio communication means 2. Diagram (b) in FIG. 2 illustrates an example of the wearable device 10a becoming the management terminal, transmitting the location information report request 50 specifying a destination as the wearable device 10a, and receiving location information 60. However, as will be described later, a form of the management terminal is not limited thereto.

As described above, wearable terminals in the group management system according to the present example embodiment confirm each other's location by use of short-distance radio communication having low power consumption while a member (wearable terminal) departed the group does not exist. Then, only when a departed member (a wearable terminal departed from the group: hereinafter also referred to as a departed terminal) exists, a location information report request is transmitted by use of long-distance radio communication having high power consumption. Only when receiving the request, the departed terminal starts the location information acquisition means having high power consumption, acquires location information, and reports the location information by use of long-distance radio communication. By an operation as described above, a wearable device departed from a group can be promptly found while power consumption of wearable devices is normally kept low.

### Third Example Embodiment

FIG. 3 is a schematic diagram illustrating a positional relation between terminals in a group management system 1000 according to a third example embodiment. The group management system 1000 includes a plurality of wearable terminals 100 and one or more management terminals 200. While four wearable terminals 100 (100a to d) and one management terminal 200 are illustrated in this example, the numbers of wearable terminals 100 and management terminals 200 are not limited thereto.

FIG. 4 is a block diagram illustrating configurations of the wearable terminal 100 and the management terminal 200 according to the present example embodiment. The wearable terminal 100 includes a first short-distance radio communication unit 110, a first long-distance radio communication unit 120, a wearable terminal list generation unit 130, a departed terminal detection unit 140, and a location information acquisition unit 150. The management terminal 200 includes a second long-distance radio communication unit 210, a departed terminal information acquisition unit 220, and a location information report request generation unit 230.

Returning to FIG. 3, a function and an operation of each unit will be described. A plurality of wearable terminals 100 perform short-distance radio communications 300 by use of the short-distance radio communication units 110 and form an ad hoc communication network 310. Then, at least one wearable terminal 100 becomes a master, and the wearable terminal list generation unit 130 of the wearable terminal 100 generates a list of wearable terminals 100 constituting a group. The wearable terminal list may be shared with other wearable terminals 100 by use of short-distance radio communication.

The wearable terminals 100 periodically perform short-distance radio communications 300 with one another, and the departed terminal detection unit 140 confirms whether each terminal is apart from the group. When every wearable terminal 100 listed in the wearable terminal list is present as illustrated in Diagram (a) in FIG. 3, the location information acquisition unit 150 is not started. On the other hand, when a wearable terminal 100 (departed terminal) being apart by a distance unreachable by short-distance radio exists as illustrated in Diagram (b) in FIG. 3, the terminal cannot communicate with another terminal. Then, based on inability to communicate, the departed terminal detection unit 140 detects the departed terminal. The wearable terminal 100c is the departed terminal in the example in Diagram (b) in FIG. 3. When the departed terminal detection unit 140 detects the departed terminal, the wearable terminal 100b being a master transmits a report indicating departure of the wearable terminal 100c to the management terminal 200 by use of a long-distance radio communication 400. When the management terminal 200 is within a reachable range of short-distance radio, a short-distance radio may be used as the communication.

The management terminal 200 acquires the information indicating departure of the wearable terminal 100c by the departed terminal information acquisition unit 220. Then, the location information report request generation unit 230 transmits, by long-distance radio, a location information report request requesting reporting of location information to the wearable terminal 100c. The wearable terminal 100c receiving the location information report request starts the location information acquisition unit 150 and acquires location information of the local terminal. Then, the wearable terminal 100c transmits the acquired location information to the management terminal 200. The management terminal 200 receiving the location information can acquire the location of the wearable terminal 100c being a departed terminal.

Hardware of the wearable terminal 100 has only to include a short-distance radio communication device, a long-distance radio communication device, a processor, a memory, and a battery. Since only a small amount of processing is required, each piece of the hardware may be small-scale and for example, may be a chip-type device; however, a cellular phone or a smartphone may also be used. When a chip-type device is used, the device can be readily attached to a shoe, clothes, or the like.

Hardware of the management terminal 200 has only to include a short-distance radio communication device, a long-distance radio communication device, a processor, a memory, and a battery. Examples of the management terminal 200 include a cellular phone, a smartphone, and a communication-capable computer. Alternatively, the management terminal 200 may be a stationary computer or a server. When the management terminal 200 includes a display, a location of a departed terminal can be displayed on the display.

Next, an operation of the group management system according to the present example embodiment will be described. FIG. 5 is a sequence diagram illustrating an example of the operation. First, the wearable terminals 100a to d form an ad hoc communication network by use of short-distance radio communication (S1). Then, a wearable terminal list is shared in the communication network (S2). Then, the wearable terminal 100c departs from the group (S3). The wearable terminal 100b being a master transmits a location confirmation (S4) but the wearable terminal 100c cannot receive the message. Then, based on a lack of a reply, the wearable terminal 100b detects departure of the wearable terminal 100c (S5). The wearable terminal 100b reports the departure of the wearable terminal 100c to the management terminal 200 by use of long-distance radio (S6). Based on the report, the management terminal 200 detects departure of the wearable terminal 100c (S7). Triggered by the detection, the management terminal 200 transmits a location information report request to the wearable terminal 100c by use of long-distance radio (S8). The wearable terminal 100c receiving the location information report request starts the location information acquisition unit 150, acquires location information (S9), and transmits the location information to the management terminal 200 (S10).

As described above, according to the present example embodiment, when every member (wearable terminal) of the group is present, location information is not acquired, and therefore power consumption of the wearable terminals can be kept very low. On the other hand, location information of a departed terminal can be promptly acquired. Then, at this time, other wearable terminals do not acquire location information, and therefore required power is low.

### Fourth Example Embodiment

FIG. 6 is a schematic diagram illustrating a positional relation between terminals in a group management system 1001 according to a fourth example embodiment. The group management system 1001 includes wearable terminals 101 and management terminals 201. The wearable terminals 101 and the management terminals 201 form the same ad hoc communication network in the present example embodiment. For example, such a configuration is applicable to situations such as a plurality of teachers leading children and tour conductors guiding tourists. While five wearable terminals 101 (101a to e) and two management terminals 201 (201a and b) are illustrated in this example, the numbers of the terminals may be larger.

FIG. 7 is a block diagram illustrating configurations of the wearable terminal 101 and the management terminal 201 according to the present example embodiment. The wearable terminal 101 includes a first short-distance radio communication unit 111, a first long-distance radio communication unit 121, and a location information acquisition unit 131. Functions of the units are similar to those according to the second example embodiment, and therefore description thereof is omitted.

The management terminal 201 includes a second short-distance radio communication unit 211, a second long-distance radio communication unit 221, a wearable terminal list generation unit 231, a departed terminal detection unit 241, and a location information report request generation unit 251.

Returning to FIG. 6, a function and an operation of each unit will be described. The plurality of wearable terminals 101 and management terminals 201 perform short-distance radio communication and form an ad hoc communication network as illustrated in Diagram (a) in FIG. 6. Then, the management terminal 201 generates a list of wearable terminals 101 constituting a group by use of the wearable terminal list generation unit 231. It is assumed in this example that the management terminal 201a is a master.

The wearable terminals 101 and the management terminal 201 periodically perform short-distance radio communication, and the departed terminal detection unit 241 confirms whether each terminal is apart from the group. When every wearable terminal 101 listed in the wearable terminal list is present as illustrated in Diagram (a) in FIG. 6, the location information acquisition unit 131 is not started. On the other hand, when a wearable terminal 101 (departed terminal) being apart by a distance unreachable by short-distance radio exists as illustrated in Diagram (b) in FIG. 6, the terminal cannot communicate with another terminal. Then, based on inability to communicate, the departed terminal detection unit 241 detects the departed terminal. The wearable terminal 101a is the departed terminal in the example illustrated in Diagram (b) in FIG. 6.

When the departed terminal detection unit 241 in the management terminal 201a detects the departed terminal, the location information report request generation unit 251 transmits a location information report request requesting location information to the wearable terminal 101a by long-distance radio. The wearable terminal 101a receiving the location information report request starts the location information acquisition unit 131 and acquires location information of the local terminal. Then, the wearable terminal 101a transmits the acquired location information to the management terminal 201a. The management terminal 201a receiving the location information can acquire the location of the wearable terminal 101a being a departed terminal.

Hardware of the wearable terminal 101 may be similar to that according to the third example embodiment; however, since an amount of processing performed in the wearable terminal 101 is less in the present example embodiment, the hardware may have lower performance and lower capacity compared with that according to the third example embodiment.

Hardware of the management terminal 201 has only to include a short-distance radio communication device, a long-distance radio communication device, a processor, a memory, and a battery. Examples of the management terminal 201 includes a cellular phone, a smartphone, and a tablet terminal. When the management terminal 201 includes a display, a location of a departed terminal can be displayed on the display.

Next, an operation of the group management system according to the present example embodiment will be described. FIG. 8 is a sequence diagram illustrating an example of the operation. First, the wearable terminals 101a to e and the management terminals 201a and b form an ad hoc communication network by use of short-distance radio communication (S101). Then, by use of the communication network, the management terminal 201 generates a wearable terminal list (S102). It is assumed that the two management terminals 201a and b share the wearable terminal list. Next, the wearable terminal 101a departs from the group (S103). The management terminal 201a transmits a location confirmation (S104) but the wearable terminal 101a cannot receive the message. Then, based on a lack of a reply, the management terminal 201a detects departure of the wearable terminal 101a (S105). Triggered by the detection, the management terminal 201a transmits a location information report request to the wearable terminal 101a by use of long-distance radio (S106). The wearable terminal 101a receiving the location information report request starts the location information acquisition unit 131, acquires location information (S107), and transmits the location information to the management terminal 201a (S108).

While the operation in FIG. 8 is an operation of the management terminal 201 detecting departure, transmitting a location information report request, and receiving location information, the operation may be an operation of the management terminal 201 detecting departure and the wearable terminal 101 transmitting a location information report request and receiving location information. FIG. 9 is a sequence diagram illustrating the operation. An operation up to S105 in which departure of the wearable terminal 101a is detected is the same as that in FIG. 8. After S105, the management terminal 201a requests, by short-distance radio communication, the wearable terminal 101b to transmit a location information report request (S106a). In response to the request, the wearable terminal 101b transmits a location information report request to the wearable terminal 101a by use of long-distance radio communication (S107a). In response to the request, the wearable terminal 101a acquires location information (S108a) and transmits the location information to the wearable terminal 101b by use of long-distance radio communication (S109a). By the operation described above, the wearable terminal 101b can acquire the location of the wearable terminal 101a. The destination of the location information in S109a may be configured to be either one of the management terminals 201a and b.

As described above, the present example embodiment can provide an effect similar to that of the second example embodiment with a less expensive wearable terminal configuration.

### Fifth Example Embodiment

FIG. 10 is a schematic diagram illustrating a positional relation between terminals in a group management system 1002 according to a fifth example embodiment. The group management system 1002 includes a plurality of wearable terminals 102. In the present example embodiment, one of the wearable terminals 102 serves as a master (management terminal), and an effect similar to that of the third example embodiment can be provided by use of the same wearable terminal 102 only. FIG. 11 illustrates an example of a configuration of a wearable terminal achieving the purpose. The wearable terminal 102 includes a short-distance radio communication unit 112, a long-distance radio communication unit 122, a wearable terminal list generation unit 132, a master arrangement unit 142, a departed terminal detection unit 152, a location information report request generation unit 162, and a location information acquisition unit 172.

Returning to FIG. 10, a configuration and an operation of the group management system 1002 will be described. First, the wearable terminals 102 (102a to g) constituting a group form an ad hoc communication network. At this time, a wearable terminal being a master functioning as a management terminal is determined. The wearable terminal 102c is selected as a master in the example in FIG. 10. A master may be determined by any method, and for example, a wearable terminal 102 with the highest remaining battery power may be arranged as a master. A wearable terminal being a master can be successively changed in the present example embodiment, and therefore for example, when a wearable terminal 102 with the highest remaining battery power is to be selected as a master, battery life of the group management system as a whole can be extended.

In this case, a list of wearable terminals 102 constituting the group is generated also by use of the ad hoc communication network. While the generation may be performed by any wearable terminal, at least the wearable terminal 102c being the master holds the list.

Each wearable terminal 102 periodically performs short-distance radio communication, and the departed terminal detection unit 152 confirms whether each terminal is apart from the group. When every wearable terminal 102 listed in the wearable terminal list is present as illustrated in Diagram (a) in FIG. 10, the location information acquisition unit 172 is not started. On the other hand, when a wearable terminal 102a (departed terminal) being apart by a distance unreachable by short-distance radio exists as illustrated in Diagram (b) in FIG. 10, the terminal cannot communicate with another terminal. Then, based on inability to communicate, the departed terminal detection unit 152 detects the departed terminal.

When the departed terminal detection unit 152 in the master wearable terminal 102c detects the departed terminal, the location information report request generation unit 162 transmits a location information report request to the wearable terminal 102a by long-distance radio. The wearable terminal 102a receiving the location information report request starts the location information acquisition unit 172 and acquires location information of the local terminal. Then, the wearable terminal 102a transmits the acquired location information to the master wearable terminal 102c. The wearable terminal 102c receiving the location information can acquire the location of the wearable terminal 102a being a departed terminal.

For example, hardware of the wearable terminal 102 according to the present example embodiment may be similar to that according to the second example embodiment. A wearable terminal 102 selected as a master. The master serves as a management terminal and grasps a location of a departed terminal in the present example embodiment. Accordingly, a wearable terminal 102 including a display is suitable, and for example, a smartphone is suitable.

Next, an operation of the group management system according to the present example embodiment will be described. FIG. 12 is a sequence diagram illustrating an example of the operation. First, the wearable terminals 102a to g form an ad hoc communication network by use of short-distance radio communication (S201). Then, a master is selected by use of the communication network. The wearable terminal 102c is selected as a master in this example (S202). Next, the wearable terminal 102c generates a wearable terminal list (S203). Next, the wearable terminal 102a departs from the group (S204). The wearable terminal 102c transmits a location confirmation (S205) but the wearable terminal 102a cannot receive the message. Then, based on a lack of a reply, the wearable terminal 102c detects departure of the wearable terminal 102a (S206). Triggered by the detection, the wearable terminal 102c transmits a location information report request to the wearable terminal 102a by use of long-distance radio (S207). The wearable terminal 102a receiving the location information report request starts the location information acquisition unit 132, acquires location information (S208), and transmits the location information to the wearable terminal 102c (S209).

As described above, the present example embodiment allows appropriate change of a master serving as a management terminal out of a plurality of wearable terminals. Consequently, battery life of the group management system as a whole can be extended.

A program causing a computer to execute the processing according to the aforementioned first to fourth example embodiments and a recording medium storing the program are also included in the scope of the present invention. Examples of the recording medium that may be used include a magnetic disk, a magnetic tape, an optical disk, a magneto-optical disk, and a semiconductor memory.

While the invention has been particularly shown and described with reference to example embodiments thereof, the invention is not limited to these embodiments. It will be understood by those of ordinary skill in the art that various changes in form and details may be made therein without departed from the spirit and scope of the present invention as defined by the claims.

The whole or part of the example embodiments disclosed above can be described as, but not limited to, the following supplementary notes.

### (Supplementary Note 1)

A wearable terminal including:

a short-distance radio communication means for normally performing short-distance radio communication with another wearable terminal;

a location information report request reception means for receiving a location information report request requesting reporting of location information of the local terminal;

a location information acquisition means for, when the location information report request is received, acquiring location information of the local terminal; and

a long-distance radio communication means for, when the location information is acquired, transmitting the location information to a destination specified by the location information report request by long-distance radio communication.

### (Supplementary Note 2)

The wearable terminal according to supplementary note 1, further including

a wearable terminal list generation means for generating a wearable terminal list listing one or more of the other wearable terminals with which the short-distance radio communication can be performed.

### (Supplementary Note 3)

The wearable terminal according to supplementary note 2, further including

a departed terminal detection means for, when a wearable terminal with which the short-distance radio communication cannot be performed out of one or more wearable terminals listed in the wearable terminal list exists, detecting the terminal as a departed terminal.

### (Supplementary Note 4)

The wearable terminal according to supplementary note 3, further including

a location information report request generation means for generating the location information report request to the departed terminal.

### (Supplementary Note 5)

A group management system including:

a plurality of the wearable terminals according to any one of supplementary notes 1 to 3; and

a management terminal configured to manage a location of the wearable terminal,

wherein the management terminal includes
a second departed terminal detection means for detecting the wearable terminal that cannot perform short-distance radio communication with the another wearable terminal as a departed terminal;
a location information report request generation means for generating a location information report request to the departed terminal; and
a second long-distance radio communication means for transmitting the location information report request to the departed terminal and receiving the location information transmitted from the departed terminal.

### (Supplementary Note 6)

A group management system including:

a plurality of the wearable terminals according to supplementary note 4; and

a management terminal configured to manage a location of the wearable terminal,

wherein the management terminal includes:
a second departed terminal detection means for detecting the wearable terminal that cannot perform short-distance radio communication with the another wearable terminal as a departed terminal; and
a second long-distance radio communication means for receiving the location information transmitted from the departed terminal.

### (Supplementary Note 7)

The group management system according to supplementary note 5 or 6,

wherein the management terminal includes a second short-distance radio communication means for performing short-distance radio communication with the wearable terminal.

### (Supplementary Note 8)

The group management system according to any one of supplementary notes 5 to 7,

wherein the management terminal is selected out of the wearable terminals.

### (Supplementary Note 9)

The group management system according to supplementary note 8,
wherein the selection is made based on remaining battery power of the wearable terminal.

### (Supplementary Note 10)

A wearable terminal control method including:

normally performing short-distance radio communication with another wearable terminal;

receiving a location information report request requesting reporting of location information of the local terminal;

when the location information report request is received, acquiring location information of the local terminal; and

when the location information is acquired, transmitting the location information to a destination specified by the location information report request by long-distance radio communication.

### (Supplementary Note 11)

The wearable terminal control method according to supplementary note 10, further including

generating a wearable terminal list listing one or more of the other wearable terminals with which the short-distance radio communication can be performed.

### (Supplementary Note 12)

The wearable terminal control method according to supplementary note 11, further including

when a wearable terminal with which the short-distance radio communication cannot be performed out of one or more wearable terminals listed in the wearable terminal list exists, detecting the terminal as a departed terminal.

### (Supplementary Note 13)

The wearable terminal control method according to supplementary note 12, further including

transmitting the location information report request to the departed terminal.

### (Supplementary Note 14)

A group management system control method for a group management system including a plurality of the wearable terminals according to any one of supplementary notes 1 to 4 and a management terminal configured to manage a location of the wearable terminal, the control method including, by the management terminal:

detecting the wearable terminal that cannot perform short-distance radio communication with the another wearable terminal as a departed terminal;

generating a location information report request to the departed terminal; and,

by use of long-distance radio communication, transmitting the location information report request to the departed terminal and receiving the location information transmitted from the departed terminal.

### (Supplementary Note 15)

The group management system control method according to supplementary note 14, further including, by the management terminal,

performing short-distance radio communication with the wearable terminal.

### (Supplementary Note 16)

The group management system control method according to supplementary note 14 or 15, further including

selecting the management terminal out of the wearable terminals.

### (Supplementary Note 17)

The group management system control method according to supplementary note 16,

wherein the selecting is made based on remaining battery power of the wearable terminal.

### (Supplementary Note 18)

A control program for a wearable terminal, the program causing a wearable terminal to execute:

processing of normally performing short-distance radio communication with another wearable terminal;

processing of receiving a location information report request requesting reporting of location information of the local terminal;

processing of, when the location information report request is received, acquiring location information of the local terminal; and

processing of, when the location information is acquired, transmitting the location information to a destination specified by the location information report request by long-distance radio communication.

### (Supplementary Note 19)

A control program for a management terminal in the group management system according to any one of supplementary notes 5 to 9, the program causing the management terminal to execute:

processing of detecting the wearable terminal that cannot perform short-distance radio communication with the another wearable terminal as a departed terminal;

processing of generating a location information report request to the departed terminal; and

processing of, by use of long-distance radio communication, transmitting the location information report request to the departed terminal and receiving the location information transmitted from the departed terminal.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A wearable terminal comprising:
a short-distance radio communicator normally performing short-distance radio communication with another wearable terminal;
a location information report request receiver receiving a location information report request requesting reporting of location information of the local terminal;
a location information acquisition unit, when the location information report request is received, acquiring location information of the local terminal; and
a long-distance radio communicator, when the location information is acquired, transmitting the location information to a destination specified by the location information report request by long-distance radio communication.

2. The wearable terminal according to claim 1, further comprising
a wearable terminal list generator generating a wearable terminal list listing one or more of the other wearable terminals with which the short-distance radio communication can be performed.

3. The wearable terminal according to claim 2, further comprising
a departed terminal detector, when a wearable terminal with which the short-distance radio communication cannot be performed out of one or more wearable terminals listed in the wearable terminal list exists, detecting the wearable terminal as a departed terminal.

4. The wearable terminal according to claim 3, further comprising
a location information report request generator for generating the location information report request to the departed terminal.

5. A group management system comprising:
a plurality of the wearable terminals according to claim 1; and
a management terminal configured to manage a location of the wearable terminal,
wherein the management terminal includes:
a second departed terminal detector detecting the wearable terminal that cannot perform short-distance radio with the another wearable terminal as a departed terminal;
a location information report request generator generating a location information report request to the departed terminal; and
a second long-distance radio communicator transmitting the location information report request to the departed terminal and receiving the location information transmitted from the departed terminal.

6. A group management system comprising:
a plurality of the wearable terminals according to claim 4; and
a management terminal configured to manage a location of the wearable terminal,
wherein the management terminal includes:
a second departed terminal detector detecting the wearable terminal that cannot perform short-distance radio communication with the another wearable terminal as a departed terminal; and
a second long-distance radio communicator receiving the location information transmitted from the departed terminal.

7. The group management system according to claim 5,
wherein the management terminal includes second short-distance radio communicator performing short-distance radio communication with the wearable terminal.

8. The group management system according to claim 5,
wherein the management terminal is selected out of the wearable terminals.

9. A wearable terminal control method comprising:
normally performing short-distance radio communication with another wearable terminal;
receiving a location information report request requesting reporting of location information of the local terminal;
when the location information report request is received, acquiring location information of the local terminal; and,
when the location information is acquired, transmitting the location information to a destination specified by the location information report request by long-distance radio communication.

10. A program storage medium that stores in itself a control program for a wearable terminal, the program causing a wearable terminal to execute:
processing of normally performing short-distance radio communication with another wearable terminal;
processing of receiving a location information report request requesting reporting of location information of the local terminal;
processing of, when the location information report request is received, acquiring location information of the local terminal; and
processing of, when the location information is acquired, transmitting the location information to a destination specified by the location information report request by long-distance radio communication.

11. A group management system comprising:
a plurality of the wearable terminals according to claim 2; and
a management terminal configured to manage a location of the wearable terminal,
wherein the management terminal includes:
a second departed terminal detector detecting the wearable terminal that cannot perform short-distance radio with the another wearable terminal as a departed terminal;
a location information report request generator generating a location information report request to the departed terminal; and
a second long-distance radio communicator transmitting the location information report request to the departed terminal and receiving the location information transmitted from the departed terminal.

12. A group management system comprising:
a plurality of the wearable terminals according to claim 3; and
a management terminal configured to manage a location of the wearable terminal,
wherein the management terminal includes:
a second departed terminal detector detecting the wearable terminal that cannot perform short-distance radio with the another wearable terminal as a departed terminal;
a location information report request generator generating a location information report request to the departed terminal; and
a second long-distance radio communicator transmitting the location information report request to the departed terminal and receiving the location information transmitted from the departed terminal.

13. The group management system according to claim 6,
wherein the management terminal includes second short-distance radio communicator performing short-distance radio communication with the wearable terminal.

14. The group management system according to claim 6,
wherein the management terminal is selected out of the wearable terminals.

15. The group management system according to claim 7,
wherein the management terminal is selected out of the wearable terminals.

16. The group management system according to claim 11,
wherein the management terminal is selected out of the wearable terminals.

17. The group management system according to claim 12,
wherein the management terminal is selected out of the wearable terminals.

18. The group management system according to claim 11,
wherein the management terminal includes second short-distance radio communicator performing short-distance radio communication with the wearable terminal.

19. The group management system according to claim 12,
wherein the management terminal includes second short-distance radio communicator performing short-distance radio communication with the wearable terminal.
